(19) United States
(12) Patent Application Publication
(10) Pub. No.: US 2006/0268905 A1
(43) Pub. Date: Nov. 30, 2006

(54) Method for controlling QoS and QoS policy converter

(76) Inventors: Honghong Su, Shenzhen (CN); Jinsong Xie, Shenzhen (CN); Zhaoxiang Wang, Shenzhen (CN)

Correspondence Address: CHRISTIE, PARKER & HALE, LLP, PO BOX 7068, PASADENA, CA, 91109-7068, US

(21) Appl. No.: 11/433,792

(22) Filed: May 11, 2006

Related U.S. Application Data
(63) Continuation of application No. PCT/CN04/01299, filed on Nov. 15, 2004.

(30) Foreign Application Priority Data
Nov. 13, 2003 (CN) 200310113626.5

(51) Int. Cl. H04L 12/56; H04J 3/16

(52) U.S. Cl. 370/401; 370/466

(57) ABSTRACT

The present invention discloses a method for controlling QoS, including setting a QPC for each kind of QoS guaranted services in a bearer network; transmitting a QoS guaranteed service to a corresponding QPC by the bearer network, transferring the service and carrying QoS related information in the service by the QPC, and transmitting the service to a QoS WAN according to the QoS related information by the bearer network. The present invention also discloses a kind of QPC. Through the scheme of the present invention, the services can be differentiated according to service type, so that the QoS guaranteed services can be accessed into a QoS WAN. Moreover, the existing network does not need much modification, and only a QPC loosely coupling with a bearer network needs to be added in the existing network. In addition, the scheme of the present invention further realizes service differentiation according to service type and user.

### FIELD OF THE TECHNOLOGY

The invention relates to service transmission technology in general. More specifically, the invention relates to a method for controlling Quality of Service (QoS), and a QoS policy converter (QPC) for realizing QoS control.

### BACKGROUND OF THE INVENTION

With developments of various broadband services, the demands for Internet QoS becomes higher and higher. QoS is a technology used to solve such problems as network delay and jam. That is, under normal conditions, if a network is only used in specific application systems without time limit, for example, Web applications and E-mail configurations, QoS technology is not needed. However, QoS is necessary for core applications and multimedia applications, since it should guarantee that the important services are not delayed or lost when overload or jam occurs in networks.

If a QoS mechanism is introduced, correct transmissions of important services can be insured, and meanwhile, high-efficiency network operations can be guaranteed. After the QoS mechanism is introduced, the QoS guaranteed services would be transmitted to a QoS guaranteed Wide Area Network (QoS WAN). Of course, a QoS WAN is a logical concept, and it may still be a part of a bearer network. In fact, a QoS WAN may be a procedure of a router in a bearer network marking high priority for a service stream and sending the service stream to a high priority queue, and a QoS WAN may also be a separate private network or a Virtual Private Network (VPN).

The network equipment in the prior art can implement QoS policy using such technologies as Differentiated Service (DiffServ) and MultiProtocol Label Switching (MPLS). No matter if DiffServ, MPLS or other technology is adopted, a service is mostly differentiated as QoS guaranteed service according to a physical port or a quintet including a source address, a source port, a destination address, a destination port and a protocol type. Moreover, the relationship between the service and the physical port or quintet should be configured in advance, which does not meet the demand of QoS since it is more reasonable to differentiate a QoS guaranteed service according to service type and user in practical application.

At present, there are three technical schemes commonly used in the prior art, but none of them differentiates whether a service is a QoS guaranteed service according to service type and user. The three technical schemes will be illuminated respectively as follows:

Technical Scheme 1:

The present scheme adopts a traditional QoS differentiation method, which determines whether the current service is a QoS service mainly through identification of specific fields such as source address, destination address and destination port in messages or differentiation of specific physical port. Generally, the service differentiation is further implemented through matching with an Access Control List (ACL). Taking example for a system shown in FIG. 1, the service differentiation based on a physical interface will be described hereinafter.

Node A differentiates whether a service is a QoS guaranteed service according to a physical interface. Interface A of Node A is set to forward QoS guaranteed services, so services transmitted to Interface A are regarded as QoS guaranteed services and would be forwarded to a QoS WAN. Interface B of Node A is set to forward common services, i.e. non-QoS guaranteed services, so services transmitted to Interface B are regarded as common services and would be forwarded to a WAN without QoS guarantee. In this way, since Host A is directly connected to Interface A of Node A, all services initiated by Host A will be transmitted to a QoS WAN; while Host B is connected to Interface B of Node A, so all services initiated by Host B will be transmitted to a WAN without QoS guarantee.

Node A differentiates whether a service is a QoS guaranteed service according to a source address. The address of Host A is set to forward QoS guaranteed services. Since services initiated by Host A correspond definitely to the address of Host A, Node A forwards all services initiated by Host A to a QoS WAN. Since the services initiated by Host B correspond to source addresses different from the address of Host A, Node A forwards all services initiated by Host B to a WAN without QoS guarantee.

Technical Scheme 2:

The present technical scheme adopts a strategy of trusting terminal unit. The idea of the technology is: a terminal unit pads a field related with QoS in service stream by itself, and a network unit trusts the padding made by the terminal unit and differentiates services according to the field. For example, for an IP message, the terminal unit can pad Type Of Service (TOS) domain to identify QoS. Technical scheme 2 is illuminated in FIG. 2.

Technical Scheme 3:

The present technical scheme adopts a normative routing technology. As shown in FIG. 3, a service stream requiring QoS guarantee is identified and routed to a QoS WAN by application router (App Router), while a common service stream will be routed to a WAN without QoS guarantee.

In FIG. 3, the App Router also has a routing function besides service identification function. The data transmitted into the App Router will be directly transmitted to a QoS WAN. Take the example for services following H.323 protocol which is a kind of multimedia communication protocol based on packet switch network, the App Router may be represented as an entity including a gatekeeper (GK) and a router. In addition, if an endpoint in a bearer network bearing H.323 protocol based services needs to use a QoS guaranteed service, the address of the GK needs to be configured in the endpoint, and the address information of the GK needs to be added in the service. In this way, the service will be transmitted to GK to implement corresponding QoS process. A simple flow is described as follows:

Step A. When Host A initiates a call requiring QoS guarantee, i.e., a QoS guaranteed call, it connects to the GK first. Since the App Router has GK function, signaling are normally transmitted to the App Router through the Router in FIG. 3.

Step B. The App Router determines Host X to which the media stream of Host A needs to be transmitted through analyzing the signaling.

Step C. The App Router informs, through the routing protocol, the Router to establish a routing list from Host A to Host X, and the corresponding interface is represented as I2;

Step D. The packets from Host A to Host X is transmitted to the App Router by the Router, and then transmitted into a QoS WAN by the App Router.

However, all the above schemes cannot differentiate whether packets corresponding to a certain service need QoS policy, and cannot differentiate services according to service types. At present, stream classification on high layers, for example, service differentiation on application layer is similar to service differentiation according to service type, but cannot realize service differentiation according to user identification. However, service differentiation on high layers needs to directly control equipment of bearer layer or modify the contents of bearer layer, which is very difficult to realize.

### SUMMARY OF THE INVENTION

The present invention provides a method for controlling QoS and a QoS policy converter (QPC), differentiating services on the premise of conducting minor modification to the existing bearer network and disposing the QPC anywhere in the network.

According to the method of an embodiment, a QPC is set for each kind of QoS guaranteed services in a bearer network. The QoS guaranteed services are transmitted to the corresponding QPC. The QPC carries QoS related information in the service streams, and the service streams are forwarded to a QoS WAN according to QoS related information by the bearer network.

According to the QPC of the embodiment, a network interface module provides an external interface for a signaling process module and a stream forwarding module, and processes protocols related with a bearer network; the signaling process module establishes a session through signaling exchange, transmits and receives service signaling through the network interface module, and transmits address information of service streams carried by the signaling to a management module; the management module dynamically generates forwarding information of the service streams according to the address information of the service streams transmitted by the signaling process module; the stream forwarding module receives the service streams through the network interface module, carries QoS related information in the service streams and forwards the received service streams through the network interface module according to the forwarding information transmitted from the management module.

It can be seen from the scheme of the present invention that, the advantages are as follows:

1) The scheme of the present invention can administrate QoS guaranteed services in the existing bearer network simply and quickly through adding a small quantity of QPCs and forwarding QoS guaranteed services by the QPCs.

2) The scheme of the present invention can differentiate QoS guaranteed services according to service type through setting up a QPC for each QoS guaranteed service and transferring the QoS guaranteed service by corresponding QPC; it can also differentiate QoS guaranteed services according to users initiating the services through authenticating users initiating the services by QPCs, thereby differentiating QoS guaranteed services according to service types and users.

3) The QoS policy conversion provided in the scheme of the present invention is completed implicitly, and there is no need for QPCs to control equipment of the bearer network or directly modify such content as IP or TOS domain in the bearer network, which makes the nodes of the bearer network loosely coupled with QPCs. Therefore, the scheme of the present invention has strong independence and flexibility, and the number of QPC can be increased accordingly with the number of newly-developed services.

4) Since the nodes of the bearer network are loosely coupled with QPCs, there is no need for QPCs to be disposed close to the nodes initiating QoS guaranteed services in the bearer network, and QPCs can be disposed anywhere in the bearer network, i.e. they can be disposed on the edge of the bearer network or in the core of the bearer network, which avoids disposing large numbers of equipment on the edge of the bearer network and makes the implementation very simple. Moreover, the network construction mode can be flexibly selected according to the service scale and network structure.

5) The scheme of the present invention only adds QPCs, and hardly needs to modify the existing network equipment, which makes full use of the existing equipment and protects the existing investment.

6) Since all the streams of QoS guaranteed services are transferred by QPCs, security of network is greatly improved. For example, the equipment such as firewall can regard QPCs as dependable nodes and communicate only with QPCs.

7) Baleful embezzlement for QoS resources of the bearer network can be avoided through performing identification of higher layer to services by QPCs.

8) The present invention also provides a scheme of regarding QPC as service gateway office, and provides multiple detailed embodiments.

9) The scheme of the present invention can also change priority in service streams by QPCs, making the bearer network directly forward the service streams according to the priority information carried in the service streams.

### BRIEF DESCRIPTION OF THE DRAWINGS

FIG. 1 is a schematic diagram illustrating service differentiation through access physical port or source address of technical scheme 1 in the prior art.

FIG. 2 is a schematic diagram illustrating service differentiation through trusting terminal unit of technical scheme 2 in the prior art.

FIG. 3 is a schematic diagram illustrating QoS scheme based on adopting normative routing of technical scheme 3 in the prior art.

FIG. 4 is a schematic diagram illustrating the structure of QoS policy converter (QPC) in accordance with an embodiment of the present invention.

FIG. 5 is a schematic diagram illustrating the structure of QPC adopting tunnel mode in accordance with an embodiment of the present invention.

FIG. 6 is a schematic diagram illustrating the structure of QPC adopting non-tunnel mode in accordance with an embodiment of the present invention.

FIG. 7 is a schematic diagram illustrating realization of QoS policy conversion through stream convergence in accordance with an embodiment of the present invention.

FIG. 8 is a flow chart illustrating a call by a single QPC in accordance with an embodiment of the present invention.

FIG. 9 is a schematic diagram illustrating network construction of a kind of QoS policy conversion in accordance with an embodiment of the present invention.

FIG. 10 is a schematic diagram illustrating network construction of another kind of QoS policy conversion in accordance with an embodiment of the present invention.

FIG. 11 is a schematic diagram illustrating network construction of the third kind of QoS policy conversion in accordance with an embodiment of the present invention.

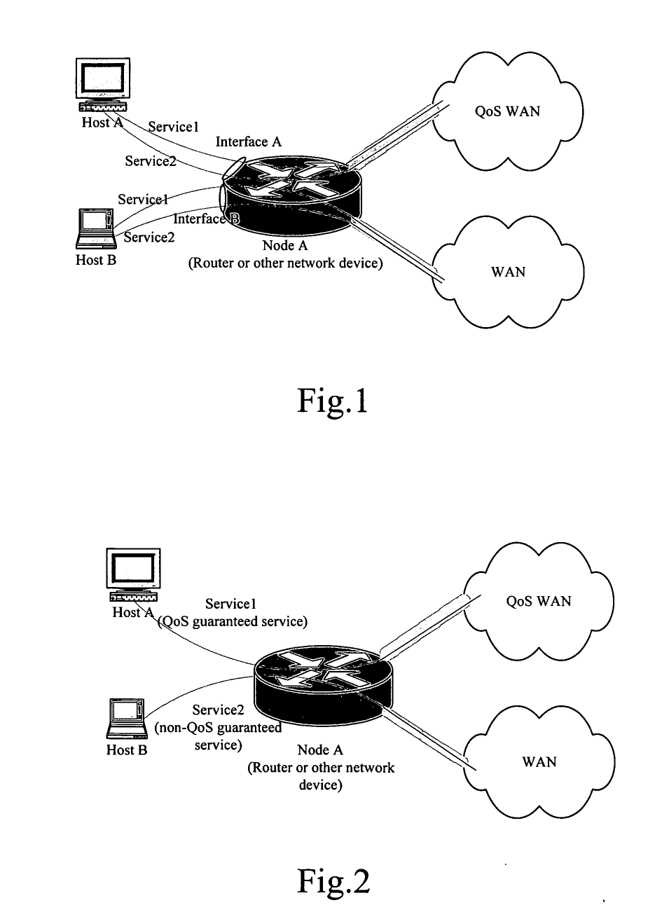

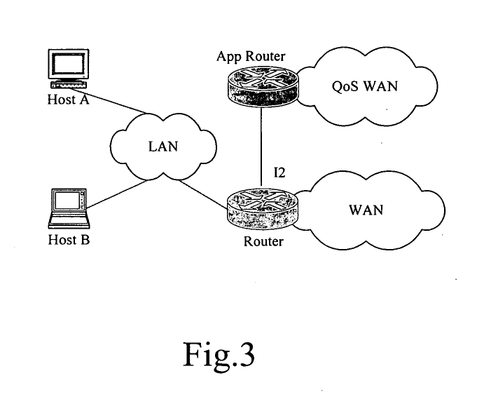

### DETAILED DESCRIPTION OF THE INVENTION

According to an embodiment of the present invention, a QPC is set for each kind of QoS guaranteed services in a bearer network. The QoS guaranteed services are transmitted to the corresponding QPC. The QPC carries QoS related information in the service streams, and the service streams are forwarded to a QoS WAN according to QoS related information by the bearer network, thereby mapping QoS policies of QPCs into service streams implicitly and implementing stream classification according to QoS policies. Here, for the network, QPCs are standard endpoint equipment that can be accessed through physical interfaces such as Fast Ethernet (FE) interface and Gigabyte Ethernet (GE) interface and logically locate in backbone layer or convergence layer.

Now, the scheme of the present invention will be described in detail hereinafter with reference to an embodiment and accompanying drawings. The procedure of the scheme comprises steps as follows:

Step A. Sets a QPC in advance for each kind of QoS guaranteed services;

Step B. The network transmits a session related with a QoS guaranteed service to a QPC corresponding to the service.

Different modes can be adopted to transmit a session related with a QoS guaranteed service to the QPC corresponding to the service according to practical applications. For example, for H.323 application, two modes can be adopted as follows:

1) Directly registers the QPC in a call agent, and set a policy in the call agent. For example, the policy is transferring a kind of call requiring QoS guarantee to the QPC corresponding to the kind of call. When a H.323 endpoint initiates a call, the call agent analyzes the call and automatically locates the call to the corresponding QPC according to the policy. Specifically, the call agent determines the corresponding QPC and sends the address of the QPC to T1, and then T1 connects to the corresponding QPC according to the address sent from the call agent.

Here, the call agent is generally a signaling process unit in application layer, e.g, a GK in H.323 application. GK is a kind of entity in network, which provides address conversion and network access control for H.323 terminals, gateways and Multi-point Control Units (MCU). GK can also provide other services such as bandwidth management and gateway locating for H.323 terminals, gateways and MCUs.

This mode may be considered as transferring some of the functions of a QPC to a call agent and locating a call into a QPC through address analysis by the call agent.

2) Sets a number prefix for each QPC, and H.323 endpoints initiate a call containing a QPC prefix and a called number. The GK analyzes the call and directs the call to the corresponding QPC according to the QPC prefix. The setting is similar to that in gateway, for example, using the number prefix 17909 when dialing IP telephone to call. It can be seen from this mode that, in fact, QPCs are selected under control of Host.

Step C. The bearer network transfers the session according to the network identifications of QPC, thereby mapping a QoS policy related with the QPC into a service stream implicitly and implementing stream classification according to QoS policy related with the QPC.

In addition, the QPCs may also implement service identification, user authentication and control for sessions, and forward the sessions according to the results of service identification and user authorization. For example, some kinds of services can be set with high priority of forwarding, so a QPC may set high priority of forwarding for a service after identifying the service and then forwards the service firstly. Another example is that a QPC may determine whether to provide a QoS guaranteed service for a user through authenticating the user, thereby realizing service differentiation based on users.

That is, when a QPC realizes service stream convergence, a QoS policy related with the QPC is mapped into a service stream implicitly, and then the QPC can implement stream classification according to the mapped QoS policy related with the QPC. For example, for an IP bearer network, after a QPC converging a service stream, the source IP address or destination IP address of the service stream related with a service on any router consequentially contains the IP address of the QPC corresponding to the service. In this way, the bearer network can implement stream classification according to the specific field in the related stream, i.e., the IP address of the QPC corresponding to the service. That is, the service may be transmitted to the QPC corresponding to the service by the bearer network according to the IP address of the QPC, and forwarded to a QoS WAN by the QPC corresponding to the service. The IP address of the QPC is one piece of QoS related information.

Obviously, if a service is not a QoS guaranteed service, the QPC does not need to implement the above-mentioned process, and the process flow can be directly ended after determining that the service is not a QoS guaranteed service.

The above-mentioned process is the main scheme in accordance with the embodiment of the present invention.

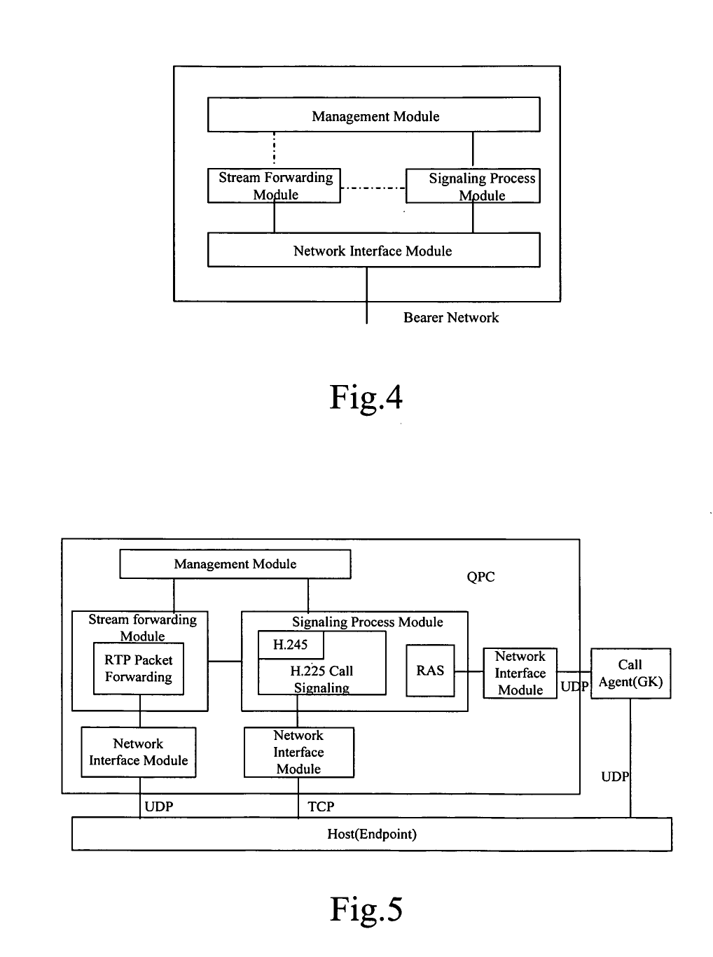

Generally, a QPC provided in the embodiment of the present invention can be divided into two parts: signaling process part and media stream process part. The signaling process part is mainly adapted for processing Registration, Admission and Status (RAS), H.225 call signaling and H.245 messages in H.323 protocol, while the media stream process part is mainly adapted for forwarding service streams. Specifically, a QPC can be divided into multiple logical entities including authentication entity, policy control entity, and stream forwarding entity. As shown in FIG. 4, the detailed structure of a QPC comprises the modules as follows:

A network interface module is adapted to provide external interfaces for a signaling process module and a stream forwarding module, and process the protocols related to the bearer network, such as IP protocol. The external interface provided by the network interface module may be FE interface, etc.

The signaling process module is adapted to process signaling of services, establish sessions, transmit and receive service signaling through the network interface module, and transmit the address information of service streams carried by the signaling to a management module.

The management module is adapted to dynamically generate forwarding information of service streams according to the address information of service streams transmitted by the signaling process module, carry the QoS related information in the service streams, and transmit the forwarding information to a stream forwarding module to control the forwarding of the streams.

The stream forwarding module is adapted to decide forwarding destinations of the service streams transmitted by the network interface module according to a forwarding list dynamically generated by the management module, and forward the received service streams through the network interface module.

The signaling process module may further provide service information needed by the management module such as information of service identification and user authentication. The management module may further perform service identification and/or user authentication according to the service information reported by the signaling process module, and generate the forwarding information according to the results of service identification and/or user authentication.

Of course, the signaling process module may further decide how and when to release a session, and transmit release information to the management module. The management module may release the items of the forwarding list related with the session.

It can be seen from the above description that, the management module also needs to generate corresponding forwarding information according to the relative information of the initiating terminal and receiving terminal of the call. Specifically, a forwarding list may be dynamically created. The forwarding list contains source and destination address information in transport layer, such as source IP address, destination IP address, source port number and destination port number, and one forwarding relationship corresponds to one item of the forwarding list. Table 1 is an exemplary forwarding list. After receiving a service stream, the stream forwarding module first looks up the forwarding list according to the source address and source port number in the service stream to determine the destination address and destination port number of forwarding the service stream, and then forwards the service stream according to the determined destination address and destination port number.

TABLE 1

| | Source | | Destination | |
|---|---|---|---|---|
| Source address | port of | Destination address | port | |
| of stream | stream | of forwarding | of forwarding | Priority |
| 10.11.12.1 | 10001 | 61.11.21.1 | 20001 | 1 |
| 10.11.12.1 | 10002 | 61.11.21.1 | 20002 | 2 |
| 10.75.44.206 | 10003 | 66.10.1.2 | 30001 | 3 |

The priority as a policy control parameter is also set in table 1, which can be used by the stream forwarding module to deploy based on the priority. The stream forwarding module may further make use of the priority in table 1 to change QoS identifications carried in the service streams, such as TOS domain in IP packet, so that the other nodes in the bearer network can forward service streams based on the priority carried in the service streams. Obviously, setting priority is only one of the schemes, and other schemes may also be adopted, for example, not to set priority or setting other control parameters. The priority and other control parameters belong to the QoS related information.

In addition, one or more network interface modules can be set according to practical demand. For one example, only one network interface module is set, and the signaling process module adapted to receive sessions and the stream forwarding module adapted to forward sessions share the network interface module. For another example, two network interface modules are set, one for the signaling process module and the other for the stream forwarding module.

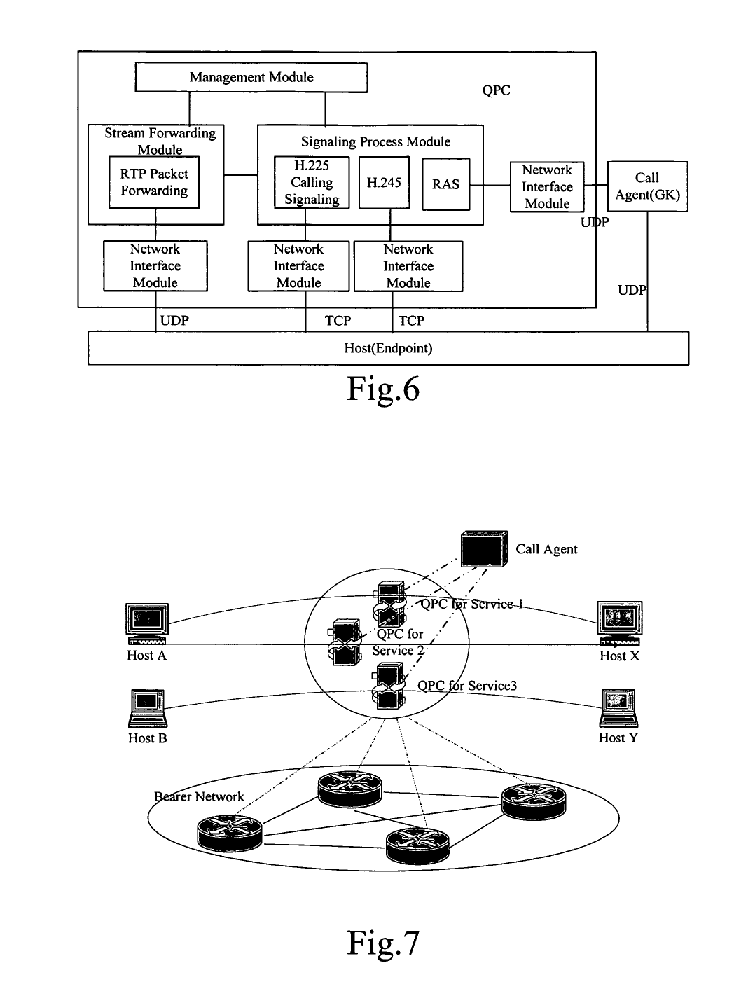

FIG. 5 and FIG. 6 show two exemplary QPCs in accordance with the embodiment of the present invention, where the QPC of FIG. 5 adopts tunnel mode and the QPC of FIG. 6 adopts non-tunnel mode. In the tunnel mode, H.245 messages are transmitted through being packaged in H.225 call signaling. In the non-tunnel mode, H.245 messages are transmitted in an individual logical channel.

The signaling process module in FIG. 5 further comprises a H.225 call signaling process module containing a H.245 module, and a RAS module. Here, the H.225 call signaling process module is connected with Hosts in the bearer network through the network interface module supporting TCP to transmit the service signaling to H.323 nodes, receive the service signaling from H.323 nodes, and transmit the address information of the service streams carried in the service signaling to the management module. The RAS module is connected with a GK through the network interface module supporting UDP to process the information exchanged between the RAS module and the GK.

The signaling process module in FIG. 6 comprises a H.225 call signaling process module, a H.245 module and a RAS module. The signaling process module may transmit the address information of the service streams carried in the service signaling to the management module through the H.245 module.

In practical applications, each module of the QPC provided in the embodiment of the present invention can be disposed in different equipment. For example, the call agent in FIG. 5 or FIG. 6, as an optional call agent, may generally be a signaling process device in application layer, such as a GK in H.323 application. Therefore, as to a QoS application, the call agent can implement partial functions of the QPC. For example, the call agent may conduct the policy control and authentication that is originally implemented by the QPC, which is the first mode adopted in above-mentioned Step B. Obviously, the QPC can implement all the functions according to specific demand, and the call agent needs not to be modified.

In addition, since all the QPCs can be under unified control of the call agent, and the QPC which the Host needs to access is determined through signaling exchange with the call agent, multiple QPCs can be physically disposed in the same equipment. Each of the QPCs use different IP addresses or transport layer addresses, so the QPCs can be differentiated according to IP addresses or transport layer addresses.

If the network structure is very complicated, e.g. a countrywide network or an international network, an end-to-end connection can be realized through multiple QPCs, as shown in FIG. 7.

QoS guaranteed service transferring by the above-mentioned QPC in accordance with the embodiment of the present invention would be described hereinafter.

Suppose there are three kinds of services to be differentiated in the bearer network: Service 1, Service 2 and Service 3. Three QPCs are set for three services respectively: QPC for Service 1, QPC for Service 2 and QPC for Service 3, and three QPCs are overlaid on the bearer network. There is also a need to transfer sessions corresponding to each service into corresponding QPC, and the QPCs conduct service identification, authentication and control to converge the service streams, so that the QoS policy is mapped into the service streams implicitly. Then, the bearer network can conduct stream classification according to the information related with the QoS policies in the service streams. For example, for IP bearer network, the service streams related with Service 1 in any router would be forwarded by the QPC for Service 1, so the source or destination IP address related with Service 1 consequentially contains the IP address of the QPC for Service 1. In this way, the bearer network can conduct stream classification according to information related with the QoS policies in the service streams, i.e., the specific field in the service stream. For example, the IP address of the QPC for Service 1.

The detailed flow in accordance with the embodiment of the present invention is illustrated using the example for implementing address analysis by a GK.

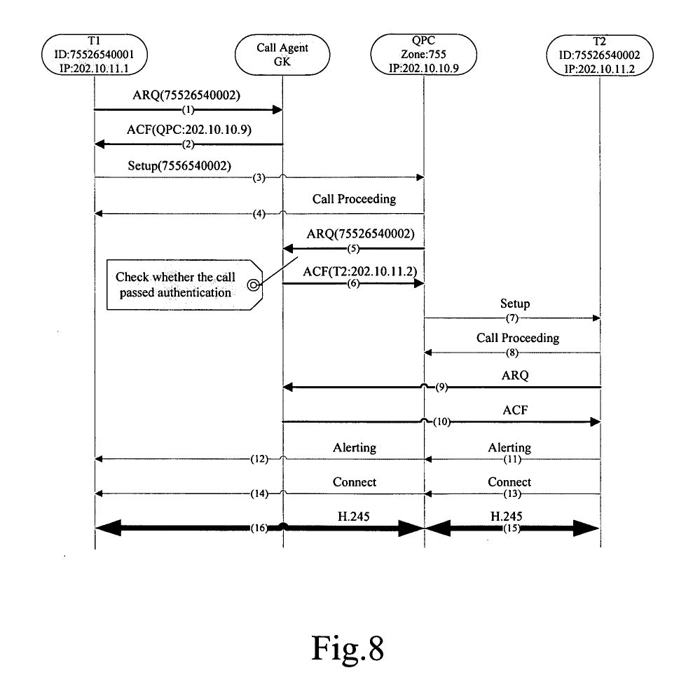

FIG. 8 shows a detailed call procedure of the embodiment of FIG. 7. To realize the procedure, firstly, QoS service zones are set on the call agent. For example, if all the terminal units which first three digits of the numbers are 755 need QoS guarantee, all these terminal units can be set to belong to the same QoS service zone, which can be called QoS-755 service zone for short. Then, a QPC is assigned for the service zone, and in the embodiment, the IP address of the service zone is 202.10.10.9, so all the calls initiated by these terminal units will be transmitted to the QPC. Of course, due to the finite process capacity of a single QPC, if the service quantity is very large in the service zone, a group of QPCs can be assigned for the service zone to share the load of the services.

Through the above configuration, the flow shown in FIG. 8 corresponds to steps as follows:

Step (1). When Ti with a number of 75526540001 initiates a call to T2 with a number of 75526540002, T1 first transmits an Admission Request (ARQ) message to the GK, and the called number carried in the ARQ message is 75526540002.

Step (2). After determining that T1 belongs to QoS-755 service zone, and has service right and sufficient residual bandwidth, the GK analyzes the call and directs the call to the QPC and returns an Admission Confirmation (ACF) message to T1. Here, the address of the call directed to the QPC is the address of the QPC. If T1 does not belong to QoS-755 service zone, or T1 has no service right or sufficient residual bandwidth, the GK rejects the call or directly transfers the call to the T2. Here, the right of the user can be authenticated through determining whether T1 belongs to QoS-755 service zone.

Step (3). Upon receiving the ACF message transmitted from the GK, T1 connects the QPC and sends a SETUP message, and the called number is also 75526540002.

Steps (4)˜(5). Upon receiving the SETUP message sent by T1, the QPC sends a Call Proceeding message to T1, and sends an ARQ message to the GK, requesting the GK to analyze the address of the called number of 75526540002.

Step (6). After determining the call is initiated by the QPC, the GK checks whether the call is correlative with the call in Step (1), if the call is correlative with the call in Step (1), the GK returns an ACF message containing the actual address of T2 to the QPC.

Steps (7)˜(16) The QPC calls T2, completes call transferring from T1 to T2, and then forwards service streams between T1 and T2.

The above steps describe a way of stream convergence through single QPC. During a call removing process, the QPC only needs to forward an EndSession Command message and a Release Complete message to the called end, that is, forwards the messages to T1 if the call is initiated by T1, or forwards the messages to T2 if the call is initiated by T2. Then transmit a Disengage Request (DRQ) message to the GK.

The scheme in accordance with the embodiment of the present invention will be further illustrated with reference to several typical network construction modes hereinafter.

In the first network construction mode, the stream classification demand of application layer is converted to a physical port or source address.

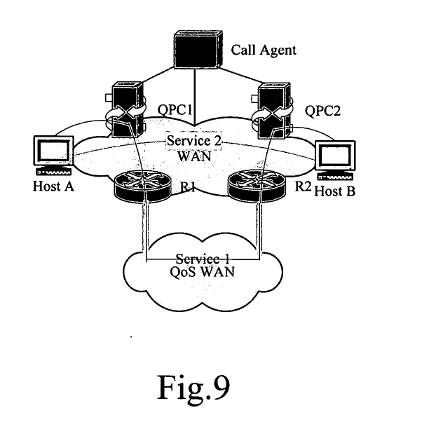

This kind of network construction mode is shown in FIG. 9. In FIG. 9, QPC1 and QPC2 are set on the edge of the network requiring QoS guarantee. If the set QPCs are applied in the whole network, they can be disposed on convergence layer. In practical applications, the number of QPCs for a certain service can be one or more than one. In FIG. 9, R1 and R2 are routers. Call Agent is a call agent, and commonly it is a signaling process equipment of application layer, such as a GK in H.323 application.

In addition, the packets whose source IP address is the address of QPC1 need to be set on R1 as service data requiring QoS guarantee; and the packets whose source IP address is the address of QPC2 need to be set on R2 as service data requiring QoS guarantee. Therefore, R1 is a gateway of QPC1, and R2 is gateway of QPC2.

Through the above configuration, if Host A needs to establish a session of Service 1 with Host B, Call Agent first controls the session requiring QoS guarantee, i.e., the session of Service 1 will be transferred by QPC1 and QPC2, while non-QoS guaranteed services are not transferred through QPC. Since the gateway of QPC1 is R1, and the gateway of QPC2 is R2, the service streams of Service 1 are consequentially transmitted to R1 and R2. Since the service streams whose source IP address is the address of QPC1 are set on R1 as requiring QoS guarantee, R1 will transmit the service streams to a QoS WAN, thereby realizing QoS guarantee of Service 1. Since Service 2 is a non-QoS guaranteed service, Call Agent will not permit it to be transmitted into the QPC. Therefore, Service 2 will not be transmitted into a QoS WAN.

Obviously, if QPC1 is directly connected to a certain physical port of R1, R1 can be set as identifying services according to the physical port, which is the same with R2.

In the network construction mode to be described hereinafter, the stream classification demand of application layer is converted to a destination address.

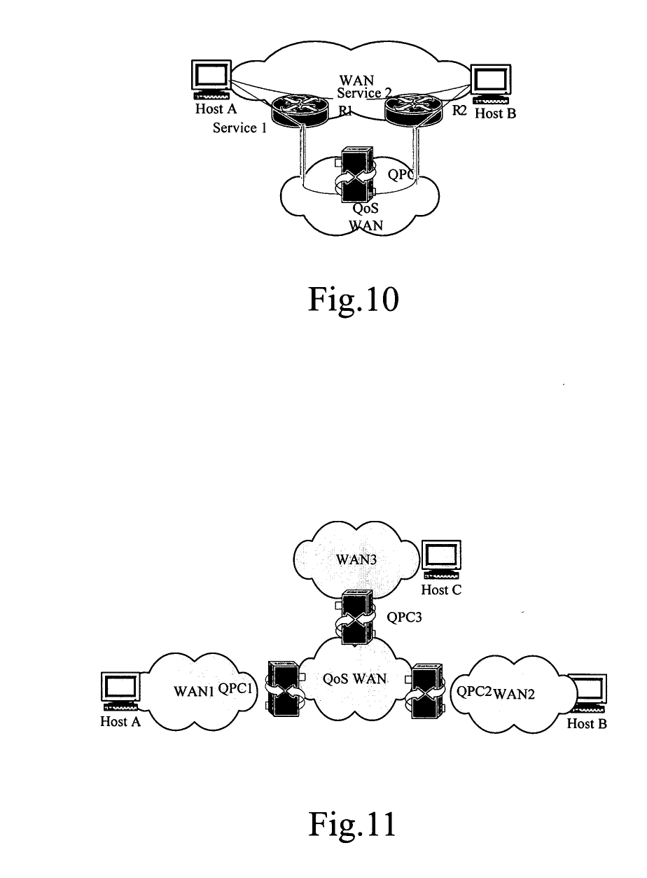

FIG. 10 shows an example of this network construction mode. The difference between this mode and the mode illustrated in FIG. 9 is: in this mode, The QPCs can be disposed in areas close to the core of the network, such as in backbone layer, and the number of QPCs can be one or more than one, thereby avoiding disposing large numbers of QPCs on the edge of the network. The QPC in FIG. 10 is disposed in a QoS WAN. In addition, the optional Call Agent is omitted in FIG. 10.

Based on the network construction mode shown in FIG. 10, the service stream whose destination address is the address of the QPC will be set first as requiring QoS guarantee in all the edge routers in the bearer network. Then the Call Agent transfers the service streams of Service 1 requiring QoS guarantee to the QPC, and the information related with the destination address of the service stream is the address information of the QPC.

Through the above configuration, in FIG. 10, when the service stream from Host A to the QPC passes through R1, since the destination address of the service stream is the address of the QPC, R1 will transmit the service stream to a QoS WAN, thereby realizing QoS guarantee of the service. Of course, the service stream will be transmitted into QPC and transferred by the QPC. The process of R2 is the same as that of R1. Since Service 2 is a non-QoS guaranteed service, the Call Agent will not transfer the service stream of Service 2 to the QPC, and the destination address of the service stream of Service 2 is not the address of the QPC. Therefore, R1 and R2 will not transmit the service stream of Service 2 into a QoS WAN.

Both of the above-mentioned two network construction modes give detailed stream classification mode. In practical applications, the stream classification demand of application layer may also be converted to a combination of destination addresses and destination ports, or other information, and all network construction modes can be used in combination. For example, a part of QPCs are disposed on the edge of the network and a part of QPCs are disposed in the core area of the network.

As shown in FIG. 11, a third network construction mode will be given hereinafter. This kind of network construction mode can be regarded as a special case of the network construction mode shown in FIG. 9. In practical applications, a service gateway office may be formed in this kind of network construction mode, so the network construction mode is proposed solely.

In FIG. 11, QoS guaranteed services need to be interconnected among three different WANs, and the bandwidth among the WANs is finite. The QPCs are disposed on the edge of the interconnection, so that all the service streams related with the physical ports of the QPCs may be QoS guaranteed. The appropriate maximum bandwidth is set on the QPCs.

Taking the example for the interconnection between Host A and Host C, the session establishing procedure comprises the following steps:

Step (1). Host A requests a service session with QoS guarantee with Host C.

Step (2). Host A connects to QPC1 first; QPC1 performs service authentication to the session and determines whether the residual bandwidth is enough, if so, the request will be transferred to QPC3; otherwise, the request will be rejected.

Step (3) QPC3 determines whether the residual bandwidth is enough, if so, a QoS guaranteed connection between QPC1 and QPC3 will be established, and the request will be transferred to Host C; otherwise, the request will be rejected.

Step (4). A QoS guaranteed session is established between Host A and Host C through QPC1 and QPC3.

It can be seen from the network construction mode shown in FIG. 11, the QPC serves as a gateway office for service interconnection among different WANs. Converging all the interconnected services to the QPC can not only guarantee service QoS using finite bandwidth, but also monitor and control services effectively.

In practical applications, the scheme in accordance with another embodiment of the present invention can make the service streams partially pass through the QPC and transferred by the QPC, so as to apply corresponding QoS policies only to the transferred service streams.

To sum up, the above description is only the preferred embodiments of the present invention and is not to be construed as limiting the protection scope thereof.

1. A method for controlling quality of service (QoS), comprising:
setting a QoS policy converter (QPC) for each kind of QoS guaranteed services in a bearer network;
transmitting one of the QoS guaranteed services to the corresponding QPC by the bearer network, transferring a service and carrying QoS related information in the service by the QPC, and transmitting the service to a QoS WAN according to the QoS related information by the bearer network.

2. The method according to claim 1, further comprising: a call agent in the bearer network determining a corresponding relationship between each of the QoS guaranteed services and a corresponding QPC;
wherein said transmitting the service to the corresponding QPC comprises: a call agent in the bearer network determining the QPC corresponding to the service according to the corresponding relationship and transmitting the service to the corresponding QPC.

3. The method according to claim 2, wherein the call agent determining the corresponding relationship comprises: the call agent determining the corresponding relationship through interaction with the QPC, or according to a preset corresponding relationship.

4. The method according to claim 2, wherein the service adopts H.323 protocol, and the call agent is a Gatekeeper (GK).

5. The method according to claim 3, wherein the service adopts H.323 protocol, and the call agent is a GK.

6. The method according to claim 1, further comprising: setting a piece of identification information for each of the QPCs;
Wherein said transmitting a service to a corresponding QPC comprises: the bearer network determining a corresponding QPC according to the identification information carried by the service, and transmitting the service to the corresponding QPC.

7. The method according to claim 6, wherein:
the service adopts H.323 protocol, and the identification information is an access code; a terminal in the bearer network initiates a call containing the access code and a called number;
said determining a corresponding QPC according to the identification information carried by the service comprises: a GK in the bearer network determining the corresponding QPC according to the access code in the call.

8. The method according to claim 1, further comprising before transmitting the service to the QoS WAN: the QPC performing at least one of authenticating to a user corresponding to the service and service identification, and executing subsequent steps according to at least one of the result of authentication and the result of service identification.

9. The method according to claim 1, further comprising before transmitting the service to the QoS WAN according to the network identification: the QPC determining a current residual bandwidth, and executing subsequent steps according to the determined current residual bandwidth.

10. The method according to claim 8, further comprising before transmitting the service to the QoS WAN according to the network identification: the QPC determining a current residual bandwidth, and executing subsequent steps according to the determined current residual bandwidth.

11. The method according to claim 1, wherein:
said transferring the service comprises: creating a forwarding list according to correlative information of the terminal initiating the call and the terminal receiving the call, and transferring the service according to the forwarding list;
said forwarding list at least comprises a piece of source address information and a piece of destination address information corresponding to each of service streams.

12. The method according to claim 1, wherein the QoS related information comprises a network identification of the corresponding QPC;
the network identification of the QPC comprises at least one of: a physical layer address, a link layer address, a network layer address and a transmission layer address of the QPC.

13. The method according to claim 12, wherein the QoS related information further comprises a piece of priority information corresponding to each of the service streams.

14. The method according to claim 13, wherein the carrying the QoS related information in the service comprising: the QPC modifying a piece of priority information carried in each of the service streams according to the priority information in the QoS related information.

15. A quality of service (QoS) policy converter (QPC), comprising:
a network interface module, for providing an external interface for a signaling process module and a stream forwarding module, and processing protocols related with a bearer network;
the signaling process module, establishing a session through signaling exchange, transmitting and receiving service signaling through the network interface module, and transmitting address information of service streams carried by the signaling to a management module;
the management module, dynamically generating forwarding information of the service streams according to the address information of the service streams transmitted by the signaling process module;
the stream forwarding module, receiving the service streams through the network interface module, carrying QoS related information in the service streams and forwarding the received service streams through the network interface module according to the forwarding information transmitted from the management module.

16. The QPC according to claim 15, wherein the management module further generates the forwarding information according to a preset service forwarding policy and the address information of the service streams.

17. The QPC according to claim 15, wherein:
the signaling process module further transmits a piece of service related information to the management module;
the management module performs at least one of service identification and user authentication according to the service related information transmitted by the signaling process module, and generates the forwarding information according to at least one of the result of service identification and the result of user authentication.

18. The QPC according to claim 15, wherein the forwarding information transmitted from the management module to the stream forwarding module is a forwarding list, and the forwarding list at least comprises a piece of source address information and a piece of destination address information for each of the service streams.

19. The QPC according to claim 18, wherein the QoS related information comprises a piece of priority information for each of the service streams.

20. The QPC according to claim 19, wherein the stream forwarding module modifies the priority information carried in the service streams according to the priority information.

21. The QPC according to claim 16, wherein the forwarding information transmitted from the management module to the stream forwarding module is a forwarding list, and the forwarding list at least comprises a piece of source address information and a piece of destination address information for each of the service streams.

22. The QPC according to claim 21, wherein the QoS related information comprises a piece of priority information for each of the service streams.

23. The QPC according to claim 17, wherein the forwarding information transmitted from the management module to the stream forwarding module is a forwarding list, and the forwarding list at least comprises a piece of source address information and a piece of destination address information for each of the service streams.

24. The QPC according to claim 23, wherein the QoS related information comprises a piece of priority information for each of the service streams.

25. The QPC according to claim 15, wherein:
the QPC is set in the bearer network that bears H.323 protocol based services;
the signaling process module further comprises:
a H.225 call signaling process module, connected with H.323 nodes through the network interface module supporting transmission control protocol (TCP), for transmitting the service signaling to the H.323 nodes, receiving the service signaling from the H.323 nodes, and transmitting the address information of the service streams carried by the service signaling to the management module;
a Registration, Admission and Status (RAS) module, connected with the GK through the network interface module supporting user datagram protocol (UDP), for registering and/or authenticating through signaling exchange with the GK;
the network interface module providing connection for the stream forwarding module supports UDP.

26. The QPC according to claim 15, wherein:
the QPC is set in the bearer network bearing H.323 protocol based services;
the signaling process module further comprises:
a H.245 signaling process module, connected with H.323 nodes through the network interface module supporting TCP, for transmitting the service signaling to the H.323 nodes, receiving the service signaling from the H.323 nodes, and transmitting the address information of the service streams carried by the service signaling to the management module;
a RAS Module, connected with the GK through the network interface module supporting UDP, for registering and/or authenticating through signaling exchange with the GK;
the network interface module providing connection for the stream forwarding module supports UDP.
